(19) United States
(12) Patent Application Publication
(10) Pub. No.: US 2007/0179693 A1
(43) Pub. Date: Aug. 2, 2007

(54) Device for impact sensing

(76) Inventors: Anton Dukart, Gerlingen (DE); Ulrike Groeger, Howell, MI (US); Frank Mack, Stuttgart (DE); Sascha Steinkogler, Freiburg (DE)

Correspondence Address: KENYON & KENYON LLP, ONE BROADWAY, NEW YORK, NY, 10004, US

(21) Appl. No.: 10/590,567

(22) PCT Filed: Dec. 17, 2004
(86) PCT No.: PCT/EP04/53554

§ 371 Date: Aug. 22, 2006

(30) Foreign Application Priority Data
Feb. 26, 2004 (DE) 10 2004 009 301.6

(51) Int. Cl. B60R 22/00

(52) U.S. Cl. 701/45; 701/301

(57) ABSTRACT

A device for impact sensing having an acceleration sensor mechanism on the bumper. The acceleration sensor mechanism is situated between the bumper and a bumper fascia.

### FIELD OF THE INVENTION

The present invention is based on a device for impact sensing.

### BACKGROUND INFORMATION

German Patent Application No. DE 101 45 698 A1 describes a sensor system for a vehicle in which acceleration sensors are situated on the bumper.

### SUMMARY

A device according to an example embodiment of the present invention for impact sensing may have the advantage that the acceleration sensor mechanism is situated between the crossmember of the bumper and the bumper fascia. A fixed connection of the acceleration sensor mechanism to the bumper fascia may be particularly advantageous. Due to the installation location behind the bumper fascia, a reliable acquisition of acceleration signals is possible. The device according to the example embodiment of the present invention may be particularly well-suited for recognizing pedestrians. The installation of the acceleration sensor mechanism in the bumper takes advantage of the fact that in the case of an accident involving a pedestrian the signal strength there increases significantly, because the acceleration sensor mechanism is situated closer to the point of impact, while on stretches of bad road the signal strength decreases due to a decoupling from the chassis. Accordingly, the installation location according to the present invention achieves a reliable and rapid recognition of a collision with a pedestrian.

It is particularly advantageous that the acceleration sensor mechanism has two acceleration sensors that are attached to the bumper fascia with an offset to the center of the vehicle. In this way, it is advantageously possible to reliably recognize a collision with a pedestrian that does not take place centrically. In addition, the position of the impact can be determined. Furthermore, it is advantageous that at least one additional sensor mechanism is situated on the bumper. This can include for example a piezo cable having an integrated capacitive sensor, capable of recognizing not only a collision but also an approach to an obstacle (i.e., an impending collision). Due to the combination of various sensor mechanisms, an even more reliable recognition of an impact with a pedestrian is possible. Distinguishing between a pedestrian and some other collision object is also made particularly simple.

The acceleration sensor mechanism for acquiring accelerations is typically configured in the longitudinal direction of the vehicle (x direction); however, it is possible to use a different sensing direction, for example the transverse direction of the vehicle (y direction) or the vertical direction (z direction), or the x/y direction (angled), or an arbitrary combination of sensors in various directions.

Finally, it may also be advantageous that the device is connected to a control apparatus for controlling equipment for protecting persons, so that the control apparatus controls the protective equipment dependent on signals from the acceleration sensor mechanism and additional sensor mechanisms. In particular, besides the signal from the acceleration sensor mechanism, a signal representing the vehicle's inherent speed, or its speed relative to the collision object, can also be used.

### BRIEF DESCRIPTION OF THE DRAWINGS

Exemplary embodiments of the present invention are shown in the figures, and are explained in further detail below.

FIG. 1 shows a top view of a device according to an example embodiment of the present invention.

FIG. 2 shows a block diagram.

### DETAILED DESCRIPTION OF EXAMPLE EMBODIMENTS

Due to new legislation in the European Union, automobile manufacturers are now required to reduce injuries to pedestrians in collisions with vehicles. This can be achieved on the one hand by constructing the front of the vehicle in such a way that the pedestrian is less seriously injured in such a collision. Thus, a passive solution is available. However, if the passive solution is not sufficient, or is rejected as unsatisfactory, an active solution is pursued. Here, a sensor mechanism is used to recognize the impact with a pedestrian, and the protection of the pedestrian is then achieved by triggering suitable protective equipment, such as external airbags, or lifting the hood.

In this active solution, various sensor designs can be used. These include in particular the acceleration sensor. Acceleration sensors are already installed in the front of the vehicle in order to act as what are known as up-front sensors. These are installed for example on the radiator supports. However, for protecting pedestrians this has the disadvantage that potholes, curb stones, and other uneven features of a road generate signals and amplitudes similar to those produced in a collision with a pedestrian. It is therefore fairly difficult to distinguish between an accident involving a pedestrian and uneven features of the road.

According to an embodiment of the present invention, acceleration sensors are situated between the bumper fascia and the crossmember of the bumper. In this way, when there is a collision with a pedestrian the signal is particularly high, and the decoupling from the chassis is such that stretches of rough roadway and potholes generate only a low signal.

With the aid of the example device according to the present invention and a suitable evaluation of the signals produced by the device, it is possible to distinguish between a collision with a pedestrian and traveling over a section of bad road, as well as other cases of false activation.

The device according to an example embodiment of the present invention may operate with one acceleration sensor; however, it may be advantageous to use two acceleration sensors having an offset to the right and to the left, for example positioned 60 cm from the center of the vehicle, in order to reliably recognize pedestrian impacts that do not take place centrically and to deliver positional data. Of course, it is possible to provide still more acceleration sensors in order to achieve an even more precise resolution.

In addition, it is possible to combine one or more acceleration sensors behind the bumper fascia with other sensors, such as for example a piezo cable or acceleration sensors at other installation locations, such as a central sensor, or sensors fastened to crossmembers or having other directions of measurement, for example in the vertical direction of the vehicle. Likewise, the knowledge of the vehicle's inherent speed, for example via the CAN bus, or of its relative speed, for example via an environmental sensor mechanism, can also be taken into account in the decision for the triggering of the protective equipment.

There are various possible ways of using the measured signals for up-front sensing. For example, information concerning the type of barrier (hard, soft, offset or complete coincidence), the relative speed between the automobile and the object, and the exact point in time of the impact can be used by the airbag algorithm.

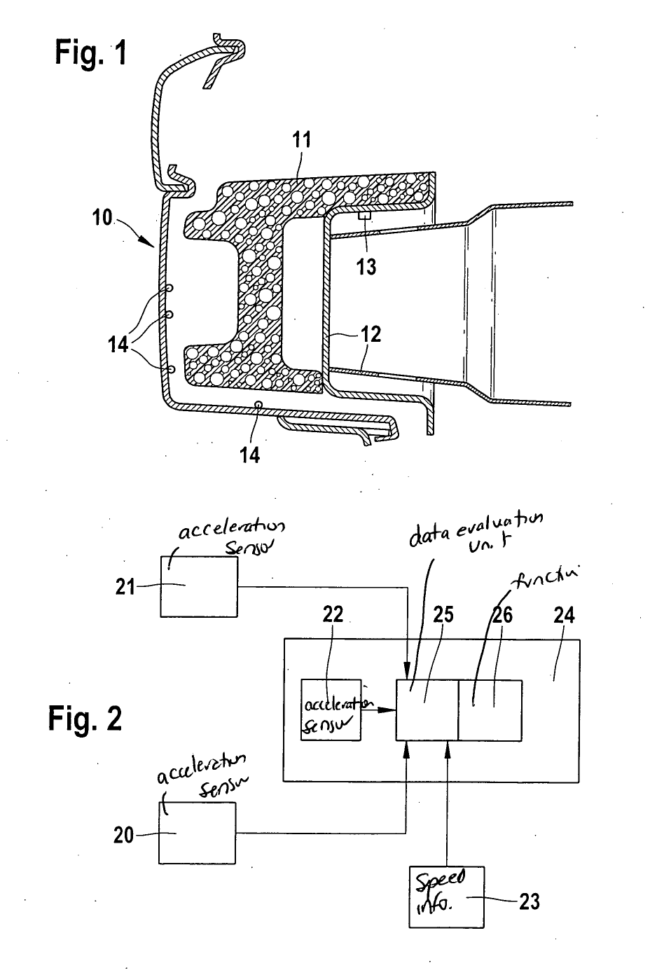

FIG. 1 shows a top view of the device according to the present invention. A bumper fascia 10 is situated in front of a foam 11 and crossmember 12. Acceleration sensors 14 are attached to bumper fascia 10, between bumper fascia 10, foam 11, and/or crossmember 12. In addition, here it is also possible to provide additional acceleration sensors 13, as is done here for example on crossmember 12, one of the acceleration sensors also being capable of acquiring accelerations in the z direction. Acceleration sensors 14 acquire accelerations in the longitudinal direction of the vehicle.

FIG. 2 visually represents the functioning of the device according to the present invention. The sensor signals of an acceleration sensor 20 that is situated at the left in the bumper, of a second acceleration sensor 21 situated at the right in the bumper, and of a central acceleration sensor 22 situated in the airbag ECU, as well as an item of information relating to speed 23, are supplied to a control apparatus 24 having a data evaluation unit 25 and a function for distinguishing between pedestrians and stretches of bad roadway 26, in order to determine whether protective equipment such as an external airbag or an active engine hood should be controlled. Besides the sensor inputs shown here, other sensor inputs are also possible. It is also possible to use fewer sensors than are indicated.

1-7. (canceled)

8. A device for impact sensing for a vehicle, comprising:
a first acceleration sensor mechanism situated on a bumper, the first acceleration sensor mechanism being situated between a crossmember of the bumper and a fascia of the bumper.

9. The device as recited in claim 7, wherein the first acceleration sensor mechanism includes two acceleration sensors, each having an offset to a center of the vehicle.

10. The device as recited in claim 7, further comprising:
at least one additional sensor mechanism situated on the bumper.

11. The device as recited in claim 9, wherein the at least one additional sensor mechanism includes at least one of a piezo cable and an environmental sensor mechanism.

12. The device as recited in claim 7, wherein the first acceleration sensor mechanism is configured so as to acquire acceleration in a vertical direction of the vehicle.

13. The device as recited in claim 7, wherein the device is connected to a control apparatus for controlling equipment for protecting persons in such a way that the equipment for protecting persons is controlled as a function of a first signal of the first acceleration sensor mechanism and a second signal, the second signal being one of an inherent speed or a relative speed.

14. The device as recited in claim 3, wherein a second acceleration sensor mechanism is situated centrally in the control apparatus.
